(19) United States
(12) Patent Application Publication
(10) Pub. No.: US 2007/0128340 A1
(43) Pub. Date: Jun. 7, 2007

(54) Food Products, Methods of Producing the Food Products, and Methods of Distributing the Food Products and Ingredients Thereof

(76) Inventors: Stanley J. Andrews, Cudahy, WI (US); Adam Lechter, Shorewood, WI (US); Charles H. Marsland, Sudbury, MA (US); Adam Synoground, Decatur, IL (US)

Correspondence Address: ARCHER DANIELS MIDLAND COMPANY, 4666 FARIES PARKWAY, DECATUR, IL, 62526, US

(21) Appl. No.: 11/609,625

(22) Filed: Dec. 12, 2006

Related U.S. Application Data
(60) Provisional application No. 60/749,913, filed on Dec. 13, 2005.
(60) Provisional application No. 60/810,257, filed on Jun. 2, 2006.

(51) Int. Cl. A23J 1/00

(52) U.S. Cl. 426/656

(57) ABSTRACT

Food products are disclosed. Methods of producing and distributing the food products are further disclosed.

### CROSS-REFERENCE TO RELATED APPLICATIONS

This application claims the benefit of U.S. Provisional Application No. 60/749,913, filed Dec. 13, 2005, and U.S. Provisional Application No. 60/810,258, filed Jun. 2, 2006, each of the contents of the entirety of which are incorporated by this reference.

### TECHNICAL FIELD

The invention relates generally to proteinaceous food components and food products including the proteinaceous food components.

### BACKGROUND

Some food products such as chips, bars, snacks, crackers, wafers, flat breads, cookies, biscuits, breads, bagels, cakes, muffins, waffles, pancakes, french fries, meat analogs, pasta, pastries, and doughnuts have developed over the years with a focus on carbohydrate-based material formulations. This focus on carbohydrates (such as flour, sugar, starch, and derivatives of such) and their functional properties has had a major impact on manufacturing processes and equipment used to produce the food products. Food processing equipment, materials of construction, equipment design, material handling requirements and systems, process design, recipe creation and product formulation have all developed around these carbohydrate-based product formulations. Most importantly, though, these carbohydrate-based product formulations have made a permanent impact on the expectations of the consumer regarding food product taste, texture, and mouth-feel. Unfortunately, this focus on carbohydrate-based foods has also had other unwanted consequences such as an increase in obesity, irritable bowel syndrome, diabetes, and lethargy. Many of these diseases are linked to high-carbohydrate diets the western hemisphere.

In the United States, the concern over the consumption of high sugar and high fat foods by the population is being addressed by the government. In fact, in 2005, the US government revised the Dietary Guidelines for food consumption in the United States. One of the goals of the revision of the Dietary Guidelines is to stop the alarming increase in obesity among the youth in the United States as too many children are overweight due to a lack of exercise and poor eating habits. One problem in children's diets is that if the school aged children do not care for the food being offered at school cafeterias, the children are able to obtain a foodstuff such as a candy bar, or other high sugar, high carbohydrate or high fat snack out of a vending machine located at the school. Thus, some children's diets may become focused on high sugar, high carbohydrate or high fat foodstuffs.

As a result, the need for changes to the high-carbohydrate diet has become critical for the general publics' long-term health and wellness. The difficulty with enacting the necessary product formulation changes is that a change in food ingredients is usually not simple, nor just an easy substitution of one ingredient for another. For instance, the foods must still be palatable and digestible, and the foods must be capable of being successfully processed on existing manufacturing equipment, ranging from home kitchen appliances to large industrial scale equipment. Additionally, this material technology must be balanced, for it needs to not only meet the requirements of the equipment, but it must ultimately yield a food product with taste, texture and mouth-feel characteristics similar to existing carbohydrate-based food products.

Thus, any new food material technology should be multifunctional, in that it can be processed and taste similar to carbohydrate containing food products. In order to be processed, such foods would need to emulate the material characteristics exhibited by high-carbohydrate foods, including possessing controllable extensibility, elongation, volume expansion, and adhesion properties needed to be processed in common food manufacturing processes (i.e., direct reduction sheeting, lamination sheeting, extrusion, and various molding processes). The processed food materials will also be physically subjected to equipment handling, various extrusion techniques, and thickness reduction methods on automated process equipment to measurements ranging from 300 mm to as little as 0.10 mm. Conventional carbohydrate materials technology used for these common food processes has been mastered over years of engineering, work, and effort. Therefore, these processes and the equipment have been designed for processing of high-carbohydrate products.

Accordingly, there exists a need for a material base change in food processing which will yield good tasting, economical, high-protein, reduced carbohydrate or sugar foods, while the improved food product can be processed with existing equipment.

### SUMMARY OF THE INVENTION

In one embodiment, a molded food composition comprises at least 30% flour and a wheat protein isolate. In other embodiments, the molded food composition may further include at least one of emulsifier and an additional protein.

In a further embodiment, a filling composition includes 7-40% protein isolate, 3-15% shortening and a sweetener. In additional embodiments, the filling composition may further include at least one of a fiber and a flavoring.

In yet another embodiment, a food product produced with the molded food composition and the filling composition of the present invention are disclosed. The food product may optionally be coated with a coating.

In other embodiments, methods of distributing at least one ingredient or a blend of at least two ingredients of the molded food composition, the filling composition, or a combination thereof are disclosed. Methods of distributing the molded food composition, the filling composition or combinations thereof are further disclosed.

In an additional embodiment, a food composition configured as a filling includes a first protein, a sweetener, and a second protein. In this embodiment, the first protein is different than the first protein.

In a further embodiment, a food composition configured as a wafer comprises a protein isolate and a compound selected from the group consisting of a vegetable oil, an emulsifier, and combinations thereof. The food composition further includes a flour.

In yet another embodiment, a food composition includes a wafer comprising a whole wheat flour; a filling contacting at least a portion of the wafer, the filling including a fat, an oil, or a combination thereof. The food composition also includes a coating covering at least a portion of the wafer, wherein the coating includes a sweetener and a soluble fiber.

In an additional embodiment, a food composition includes a wafer having a flour and a protein selected from the group consisting of soy protein, wheat protein, whey protein, egg protein and any combination thereof. The food composition also includes a filling that contacts at least a portion of the wafer, wherein the filling comprises a protein isolate and a trans-fat free oil.

In another embodiment, a food composition includes a wafer, a filling contacting at least a portion of the wafer, and a coating covering at least a portion of the wafer. In this embodiment, twenty-six grams of the food compositions comprises at least four grams of dietary fiber and at least four grams of protein.

In yet an additional embodiment, a food product configured as a molded wafer includes whole wheat flour and a protein selected from the group consisting of soy protein, wheat protein, whey protein, canola protein, egg protein, and combinations of any thereof.

### DETAILED DESCRIPTION OF THE INVENTION

Research and development on healthier foods has continued. For instance, US Patent Application 2003/0091698 to Marsland, the contents of the entirety of which is incorporated by this reference, discloses some examples of high-protein, reduced carbohydrate food products. US Patent Application 2003/0113434 to Marsland, the contents of the entirety of which is incorporated by this reference, discloses some examples of proteinaceous wafers, waffles, inclusion ingredient, and cookie food products. The present invention discloses improved food products.

The invention relates to food material technology. In one embodiment, a food product of the present invention possesses controllable, engineered process-related functionality, including high to low break elongation, high to low tensile strength, high to low expansion, and high to low adhesion which enables the food product to be produced in commercial food processes. The food product also possesses good die cutting characteristics, molded form retention, is edible, and forms a dough-like material that, when blended with water, is processed much like a conventional high-carbohydrate dough. The food product can be formulated to work within numerous existing food process systems, including direct reduction sheeting, lamination sheeting, single and twin screw extrusion, die cutting, and molding processes followed by baking, drying, boiling, steaming, frying, seasoning, enrobing, combinations of any thereof.

Foods that may be produced include, without limitation, chips, bars, snacks, crackers, wafers, flat breads, cookies, biscuits, breads, bagels, cakes, french fries, meat analogs, pasta, pastries, breakfast cereals, pancakes, waffles, pizza dough, muffins, and doughnuts. The food product may further comprise a topical seasoning, coating or an enrobed covering to enhance the flavor of the food product.

In another embodiment, any of the food products produced herein may be used to increase the protein consumption in a population. For instance, a high-protein food product of the present invention may be placed in a vending machine at a school in order to increase the amount of protein that school children consume, while decreasing the amount of sugar or carbohydrate in the school children's diet.

Processes used to produce the food product of the present invention include, but are not limited to: the blending of food ingredients in a mixer; the conversion of the food ingredients into an extensible reduced carbohydrate, high protein dough through the addition of water and thorough mixing; the transfer, reduction and/or molding of the dough or batter to a desired thickness and shape through extrusion, die cutting, reduction sheeting, lamination sheeting processes, direct deposit, and/or rotary molding (i.e., rotary piston molding); baking, drying, exposure to microwave radiation, frying, steaming, boiling, or a combination of such for desired moisture reduction; or proteinaceous matrix curing or setting.

In other embodiments, food processing techniques that may be used include, without limitation: mixing of a reduced carbohydrate protein blend with modified wheat protein(s) (i.e., wheat protein isolates), protein concentrates, protein isolates, fats, oils, emulsifiers (i.e., lecithin or monoglyceride containing compositions), select carbohydrate materials, and combinations of any thereof if desired for flavor, texture, seasoning, bulking, gelatinization, and combinations of any thereof; the addition of water to the blend of ingredients to form a soft, extensible, cohesive, non-adhesive dough or batter; the transfer of the moist, yet solid dough to an extrusion reduction sheeter system, lamination sheeting, direct deposit, rotary molding system, or any combination thereof, wherein the final food product may be deposited, formed, sheeted, or molded to a thickness of from about 300 mm to about 0.10 mm. The reduced thickness dough may also be processed by a die cutting device for the cutting or formation of chips, bars, snacks, crackers, wafers, flat breads, cookies, biscuits, breads, bagels, cakes, french fries, meat analogs, pasta, pastries, doughnuts or other food product.

In other embodiments, individual cut or deposited food products (i.e., batters or doughs) produced herein can be placed directly onto a conveyor band. The food products may be transferred to a moisture-reduction process including, but not limited to, baking, drying, microwaving, frying, steaming, boiling, or a combination of such until the extensible protein based food reaches the desired moisture percentage and possesses durable handling strength, shelf stability, texture, flavor, crunch or any combination thereof. The final fabricated food product may also be seasoned, flavored, layered, enrobed with a topical seasoning, coated, or any combination thereof, and packaged for delivery to a consumer or food processor.

In other embodiments, the dough, batter, filling composition, coating or any combination thereof may include other ingredients including, without limitation: fruit paste; food colorants; flavoring agents; vitamins; minerals; edible oils or fats (i.e., vegetable oils, legume oils, lecithin, butter, cheese curds, natural cheese, processed cheese and/or shortening); emulsifiers; leavening agents; natural or artificial sweeteners; a sweetener solution or syrup; a nutritive sweetener; fructose; sucrose; a non-nutritive sweetener; maltitol; isomalt; lactitol; xylitol; erythritol; sorbitol; mannitol; polydextrose; inulin; tagatose; acesulfame K; sucralose; saccharin; cyclamates; aspartame; alitame; starches; thickening agents; soluble fiber (including, but not limited to, a soluble digestion resistant fiber (i.e., FIBERSOL brand digestion resistant maltodextrin available from Archer Daniels Midland Company of Decatur, Ill., OLIGGO-FIBER® brand inulin available from Cargill, Minneapolis, Minn., NUTRIOSE® brand soluble fiber available from Roquette Freres of Lestrem, France, and/or polydextrose); an insoluble fiber; a cellulose (i.e., microcrystalline cellulose or carboxymethylcellulose); maltodextrins; corn-syrup solids; potato starch; corn starch; wheat starch; a vegetable product; a fruit product; a nut product; an edible bean powder or fraction; texture modifiers (i.e., calcium carbonate and/or sodium bicarbonate); carbohydrates (i.e., fiber, gums, starches, pregelatinized starches, crystalline starches, powdered flavors, spices, herbs, texturizing agents, beta glucan-based materials, corn masa, modified flour, dried potato material, grain flours, legume flour or products, seed meal, seeds, vegetable matter); isolated or purified nutraceuticals or plant extracts (i.e. lignans, isoflavones, sterols, glucosamine or any combinations thereof); powdered flavors; spices; herbs; texturizing agents; beta-glucan based materials; a yogurt product; or combinations of any thereof. In one embodiment, the shortening may be a low trans-fat shortening such as, for example, NovaLipid brand 106-150 shortening available from Archer Daniels Midland Company of Decatur, Ill., which is an interesterified oil having zero grams of trans-fat per serving and wherein about 90% of the saturated fat of the NovaLipid brand 106-150 shortening is stearic acid. In another embodiment, the shortening may be any type of edible oil including, but not limited to, sunflower oil, canola oil, soy oil, peanut oil, cotton seed oil, palm oil, a diacylglycerol oil (i.e., ENOVA brand oil), a low trans oil, a no trans oil, or combinations of any thereof.

In other embodiments, various proteins may be added to the dough, batter, filling composition, coating or combination of any thereof. Examples of such proteins include, without limitation: wheat protein; wheat protein isolate (i.e., any chemically or enzyme catalyzed wheat protein isolate including without limitation wheat protein isolate FP 5000, Arise 5000, and Arise 6000, each available from Midwest Grain Products of Atchison, Kans.); wheat gluten (i.e., such as PROLITE brand wheat gluten available from Archer Daniels Midland Company, Decatur, Ill.); buttermilk solids; milk powders; egg protein; canola protein; pea protein; wheat protein; potato protein; corn protein; sesame protein; sunflower protein; cottonseed protein; copra protein; palm kernel protein; safflower protein; linseed protein; peanut protein; lupin protein; oat protein; soy protein; soy protein concentrates; soy protein isolates (i.e., ProFam 781, ProFam 985, or Profam 891 available from Archer Daniels Midland Company, Decatur, Ill.); edible bean proteins; wheat protein concentrate; textured wheat protein powder (i.e., available from Midwest Grain Products, Atchison, Kans.); sweetened composite protein (i.e., Beta 3000 available from Betafoods, Natick, Mass.); calcium caseinate; sodium caseinate; textured wheat protein; textured vegetable protein; whey protein concentrate; rice protein concentrate; zein; denatured proteins; oil seed proteins; hydrolyzed proteins; cheese; textured proteins; fish protein; amino acids; peptides; collagen; casein; animal protein; single cell protein; flax protein; flax meal; and mixtures of any thereof.

In additional embodiments, processes used to produce the food products of the present invention include: mixing of the various food ingredients and water (and steam if necessary) in a mixing vessel and/or extruder barrel (or preconditioner) to form a soft, moist, extensible, or non-sticky dough or batter. The dough or batter may be extruded through a die (and cut to a desired shape and size), transferred to a sheeting, lamination sheeting, or rotary molding process. The dough or batter may also be subjected to reduction or transformation into a desired shape and thickness for processing into a food product. In other embodiments, the dough or batter may be cut or formed into the desired food product shape and size through the utilization of a cutting die, rotary cutter or guillotine cutting system. The food product may also be transferred to a tunnel oven, drying, microwaving, frying (including vacuum frying), steaming, boiling process, or any combination thereof at temperatures less than 900° F., but greater than 100° F. The food product may be processed in any of these manners until the final food product reaches a desired moisture percentage of less than 25%, such as from 1% to 20%.

In other embodiments, mixture ratios of the various ingredients used in the food products produced herein may be modified for increased or decreased final nutritional levels as well as functional properties of the food product. Mixing of the various ingredients may be done by adding all ingredients directly into a single chamber, mixing with a single or double arm mixing device (including a ribbon blender), or by direct feed mixing in the barrel of an extruder and mixing or blending until thoroughly integrated. The water percentage of the dough mixture will vary according to the ingredients, protein composition, type of protein, solubility of protein, fat percentage, temperature of surrounding environment, and method of processing, and may be determined using routine experimentation.

In an additional embodiment, a molded food product may include at least 30% flour and a wheat protein isolate, which may be present at 10-70% or 10-50%. The flour may also be present at 45-70%. The molded food product may also include 3-30% of an additional protein.

In a further embodiment, a filling composition includes 7-40% protein isolate, 3-15% shortening, and a sweetener. The filling composition may also include 5-40% of a soluble fiber and, optionally, a flavoring that may be present at 10-70%.

The formed and cut food products may also be processed by baking, drying, frying, microwaving, steaming, boiling, or any combination thereof for moisture reduction. The final moisture content may be 1% to 7% for shelf stable products such as chips, bars, snacks, crackers, wafers, flat breads, cookies, pasta, biscuits, or cereals, or 2%-6.5% to avoid scorching and burning. The final moisture content may be 3%-30% for breads, bagels, cakes, pastries, french fries, meat analogs, food pellets, or doughnuts. Topical seasonings, icings, coatings, oils, fats or any combination thereof may also be added to the food product for enhanced flavor.

The dough product or batter produced herein may be processed with existing equipment in a commercial bakery, extrusion plant, pasta plant, or snack food plant, and enables high volume production of a food product that is traditionally difficult to produce at economical costs due to the fragility and lack of extensibility of high-protein dough products.

In one embodiment, the food product that is produced according to the present invention is a filling composition including a protein, a sweetener and an emulsifier. Examples of such proteins that may be used include, without limitation: wheat protein; wheat protein isolate (i.e., any chemically or enzyme catalyzed wheat protein isolate including without limitation wheat protein isolate FP 5000, Arise 5000, and Arise 6000, each available from Midwest Grain Products, or PROLITE wheat protein isolate available from Archer Daniels Midland Company, Decatur, Ill.); wheat gluten; buttermilk solids; milk powders; egg protein; canola protein; pea protein; wheat protein; potato protein; corn protein; sesame protein; sunflower protein; cottonseed protein; copra protein; palm kernel protein; safflower protein; linseed protein; peanut protein; lupin protein; oat protein; soy protein; soy protein concentrates; soy protein isolates (i.e., ProFam 781, ProFam 985, or Profam 891 available from Archer Daniels Midland Company, Decatur, Ill.); edible bean proteins; wheat protein concentrate; textured wheat protein powder (i.e., available from MGP, Atchison, Kans.); sweetened composite protein (i.e., Beta 3000 available from Betafoods, Natick, Mass.); calcium caseinate; sodium caseinate; textured wheat protein; textured vegetable protein; whey protein concentrate; rice protein concentrate; zein; denatured proteins; oil seed proteins; hydrolyzed proteins; cheese; textured proteins; fish protein; amino acids; peptides; collagen; casein; animal protein; single cell protein; flax protein; flax meal; and mixtures of any thereof. Examples of sweeteners that may be used include, without limitation: a sweetener solution, a sweetener syrup, a natural sweetener, an artificial sweetener, a nutritive sweetener, a non-nutritive sweetener, and combinations of any thereof. Examples of emulsifiers that may be used include, without limitation: monoglycerides, diglycerides, lecithin (standard, acetylated, hydroxylated and/or modified), sodium stearoyl lactylate (SSL) and SSL combinations with distilled monoglycerides, ethoxylated monoglycerides, monodiglycerides, polysorbates, polyglycerol esters, sucrose esters, succinylated monoglycerides, acetylated monoglycerides, lactylated monoglycerides, sorbitan esters, diacetyl tartaric acid esters of monoglycerides, polyglycerol polyricinoleate glycerol and any combination thereof.

In another embodiment, a composition configured as a wafer includes a protein and a vegetable oil, an emulsifier or a combination thereof. The protein may include, without limitation: wheat protein; wheat protein isolate (i.e., any chemically or enzyme catalyzed wheat protein isolate including without limitation wheat protein isolate FP 5000, Arise 5000, and Arise 6000, each available from Midwest Grain Products, or PROLITE wheat protein isolate available from Archer Daniels Midland Company, Decatur, Ill.); wheat gluten; buttermilk solids; milk powders; egg protein; canola protein; pea protein; wheat protein; potato protein; corn protein; sesame protein; sunflower protein; cottonseed protein; copra protein; palm kernel protein; safflower protein; linseed protein; peanut protein; lupin protein; oat protein; soy protein; soy protein concentrates; soy protein isolates (i.e., ProFam 781, ProFam 985, or Profam 891 available from Archer Daniels Midland Company, Decatur, Ill.); edible bean proteins; wheat protein concentrate; textured wheat protein powder (i.e., available from MGP, Atchison, Kans.); sweetened composite protein (i.e., Beta 3000 available from Betafoods, Natick, Mass.); calcium caseinate; sodium caseinate; textured wheat protein; textured vegetable protein; whey protein concentrate; rice protein concentrate; zein; denatured proteins; oil seed proteins; hydrolyzed proteins; cheese; textured proteins; fish protein; amino acids; peptides; collagen; casein; animal protein; single cell protein; flax protein; flax meal; and mixtures of any thereof.

In one embodiment, the filling composition may be incorporated into a foodstuff. Examples of such foodstuffs include, without limitations: baked goods (i.e., breads, doughs, muffins, snacks, cakes, brownies, cookies, pastries, bars and wafers), prepared foods, food ingredients, and nutritional and/or health food products, molded proteinaceous compositions (i.e., wafer, crisp, nugget, granule, puffed rice, and a pellet) and any combination thereof.

In another embodiment, the food product may be coated or enrobed. The coating may include a chocolate coating (white chocolate, milk chocolate, dark chocolate (including, without limitation, bittersweet and/or semisweet chocolates), or any combination thereof); a compound or confectionary coating; a yogurt or yogurt product; a peanut butter composition or any combination thereof. The coating may further include other ingredients which include, without limitations; fiber (soluble and insoluble); vitamins; minerals; nutraceuticals; proteins and combinations thereof.

In another embodiment, a coating of the present invention may comprise ingredients including, but not limited to, chocolate, a yogurt product, fiber, protein, and any combination thereof.

In yet a further embodiment, the various components (i.e., the wafer, the crème, and the coating) of the cookie may be each manufactured at a geographic location, and shipped or transported to a second geographic location. For instance, the wafers may be produced at a first location for shipment to a food manufacturer at a second location, such that the food manufacturer is enabled to combine the various components and create the cookie using pre-manufactured components of the cookie.

The description and claims of the present invention makes reference to various ingredients present in a food product at various ranges. It will be apparent by those of ordinary skill in the art that the percentage or range of percentages given are exemplary and may vary depending on numerous factors including, without limitation, the amount of water or moisture in the product or ingredient or known errors or variations in equipment used to measure the ingredient or product. Thus, the percentages and ranges may vary somewhat in a final food product. Further, any expressed range is meant to encompass each percent within the range. For instance, a range of 5-10% includes 5%, 10% and any value in between.

The invention is further explained by use of the following exemplary embodiments.

### EXAMPLES

### Example 1

In one embodiment, a wafer was produced with the following ingredients:

| | Dry weight |
|---|---|
| Ingredient | percentage |
| 69.0 parts wheat flour | 68.3% |
| 25.0 parts wheat protein isolate (e.g., PROLITE 200 | 24.8% |
| available from Archer Daniels Midland Company, | |
| Decatur, IL) | |
| 4.5 parts egg white protein | 4.5% |
| 2.0 parts lecithin (e.g., YELKIN SS soy lecithin available | 2% |
| from Archer Daniels Midland Company, Decatur, IL) | |
| 0.5 parts potassium bicarbonate | 0.5% |

The ingredients were mixed or blended with water to form a batter. The batter was subjected to a pressure molding system, heated, and cooked to form wafers. A cooked wafer produced with this embodiment has a mass of about 2.5 g and a moisture content of about 2%.

### Example 2

In another embodiment, a wafer was produced with the following ingredients:

| | Dry Weight |
|---|---|
| Ingredient | Percentage |
| 75 parts of wheat flour | 46.2% |
| 75 parts of wheat protein isolate (e.g., PROLITE 200 | 46.2% |
| available from Archer Daniels Midland Company, Decatur, | |
| IL) | |
| 10 parts of egg white protein | 6.2% |
| 2 parts lecithin (e.g., YELKIN SS soy lecithin available | 1.2% |
| from Archer Daniels Midland Company, Decatur, IL) | |
| 0.5 parts potassium bicarbonate | 0.3% |

The ingredients were mixed or blended with water to form a batter. The batter was subjected to a pressure molding system, heated, and cooked to form wafers. A cooked wafer produced with this embodiment has mass of about 2 g and a moisture content of about 2%.

### Example 3

In yet another embodiment, a wafer was produced with the following ingredients:

| | Dry Weight |
|---|---|
| Ingredient | Percentage |
| 65 parts of wheat flour | 63.4% |
| 12.5 parts of wheat protein isolate (e.g., PROLITE 200 | 12.2% |
| available from Archer Daniels Midland Company, Decatur, | |
| IL) | |
| 12.5 parts of soy protein isolate (e.g., PROFAM 780 | 12.2% |
| available from Archer Daniels Midland Company, Decatur, | |
| IL) | |
| 10 parts of egg white protein | 10% |
| 2 parts of lecithin (e.g., YELKIN SS soy lecithin available | 2% |
| from Archer Daniels Midland Company, Decatur, IL) | |
| 0.5 parts of potassium bicarbonate | 0.5% |

The ingredients were mixed or blended with water to form a batter. The batter was subjected to a pressure molding system, heated, and cooked to form wafers. A cooked wafer produced with this embodiment has mass of about 2 g and a moisture content of about 2%.

### Example 4

In yet another embodiment, a crème formulation was prepared with the following ingredients:

| | Dry Weight |
|---|---|
| Ingredient | Percentage |
| 50 parts soy protein isolate (e.g., PROFAM 780 | 13.3% |
| available from Archer Daniels Midland Company, | |
| Decatur, IL) | |
| 50 parts of a digestion resistant soluble fiber | 13.3% |
| (e.g., FIBERSOL digestion resistant maltodextrin | |
| available from Archer Daniels Midland Company, | |
| Decatur, IL. FIBERSOL is a trademark of | |
| Matsutani Chemical Industry | |
| Co., Ltd.) | |
| 25 parts of a shortening (e.g., low trans shortening | 6.7% |
| available from Archer Daniels Midland Company, | |
| Decatur, IL) | |
| 150 parts of a flavoring (e.g., natural peanut butter | 40% |
| comprising ground peanuts) | |
| 100 parts of a sweetener (e.g., crystalline fructose) | 26.7% |

The ingredients were blended together to form a crème type material. The crème may be used as a filling or placed between two wafers. The crème may also contain a colorant to give the crème a desired color.

### Example 5

In another embodiment, a crème formulation was prepared with the following ingredients:

| | Dry Weight |
|---|---|
| Ingredient | Percentage |
| 100 parts soy protein isolate (e.g., PROFAM 780 available | 26.6% |
| from Archer Daniels Midland Company, Decatur, IL) | |
| 25 parts of a shortening (e.g., low trans shortening available | 6.7% |
| from Archer Daniels Midland Company, Decatur, IL) | |
| 150 parts of a flavoring (e.g., natural peanut butter | 40% |
| comprising ground peanuts) | |
| 100 parts of a sweetener (e.g., crystalline fructose) | 26.7% |

The ingredients were blended together to form a crème type material. The crème may be used as a filling or placed between two wafers. The crème may also contain a colorant to give the crème a desired color.

### Example 6

In one embodiment, a crème formulation or filling composition was prepared with the following ingredients:

| Ingredient | Grams | Percentage |
|---|---|---|
| Maltitol Syrup | 259.9 | 25.99 |
| Sorbitol Solution | 358 | 35.8 |
| All purpose Shortening | 80 | 8 |
| Panalite MPB 45 LT | 20 | 2 |
| brand monoglycerides | | |
| Sweet Whey | 20 | 2 |
| Potassium Sorbate | 1 | 0.1 |
| Prolite 100 brand Wheat Protein Isolate | 40 | 4 |
| Water | 46.5 | 4.65 |
| Natural/Artificial | 5 | 0.5 |
| Raspberry Flavor | | |
| Natural/Artificial | 2.5 | 0.25 |
| Yogurt Flavor | | |
| Natural Yogurt Flavor | 2.5 | 0.25 |
| Ace-K | 0.3 | 0.03 |
| Salt | 0.5 | 0.05 |
| Instant Gel | 63.8 | 6.38 |
| FIBERSOL brand | 100 | 10 |
| digestion resistant | | |
| maltodextrin | | |

The ingredients were blended together to form a crème type material or filling composition. The crème may be used as a filling composition for incorporation into a food stuff, placed between two wafers or used as a coating for a foodstuff. The crème may also contain a colorant to give the crème a desired color.

Other uses for this crème would be inclusion in cakes, cake mixes, donuts, pastries, desserts, puddings, or any combinations thereof. This crème could also be used as a topping or a filling for cakes, cake mixes, donuts, pastries, desserts, puddings, or any combinations thereof.

### Example 7

In yet another embodiment, a wafer was prepared with the following ingredients:

| Ingredients | % in formula |
|---|---|
| Sodium BiCarbonate | 0.130434783 |
| Water | 57.26086957 |
| Egg White Powder | 1.565217391 |
| Soy protein isolate, Profam 781 | 5 |
| Soy Oil | 1.739130435 |
| Lecithin | 0.869565217 |
| Wheat flour, ADM Dominator Flour | 32.43478262 |
| Wheat protein isolate, Prolite 200 | 1 |
| Total | 100 |

The above ingredients were mixed together and formed into a batter. The batter was placed into a molded wafer plate and heated to form a wafer.

### Example 8

In yet another embodiment, a crème formulation or filling composition was prepared with the following ingredients:

| Ingredients | % in formula |
|---|---|
| Soy protein isolate, Profam 781 | 23.58078603 |
| Diacylglycerol oil, Enova Oil (made | 6.986899563 |
| from soybean oil and canola oil) | |
| NovaLipid brand 106-050 shortening, | 10.91703057 |
| 90% interesterified soybean oil with | |
| 10% hydrogenated cottonseed oil | |
| Peanut Butter (roasted peanuts and salt) | 33.62445415 |
| Sterols, CardioAid | 3.6 |
| Sugar | 19.98078603 |
| Lecithin | 1.310043668 |
| Total | 100 |

The ingredients were mixed together to form a crème type material or filling composition. The crème may be used as a filling composition for incorporation into a food stuff, placed between two wafers or used as a coating for a foodstuff. The crème may also contain a colorant to give the crème a desired color and optionally an added flavoring agent such as peanut oil flavor.

### Example 9

In yet another embodiment, a crème formulation or filling composition of the present invention is placed into a food stuff. The wafers and crème filling of the present invention are used to form a crème-filled wafer cookie. The cookie is made by placing crème filling on a wafer and/or between two wafers, thus, forming a core comprising the wafer and the crème filling.

The core may be coated or enrobed with a coating. The coating may be a chocolate coating and comprise ingredients including, but not limited to, chocolate, fiber, protein, and any combination thereof in order to increase the fiber/and or protein content of the chocolate coating.

The core may be used in a variety of different food products including, but not limited to, candy bars, breakfast bars, nutrition bars, cookies, and any other food composition that includes wafers.

The following ingredients were used to create a chocolate coated peanut butter wafer.

| Ingredients | % in formula |
|---|---|
| Chocolate Coating | 34 |
| Crème filling (from Example 3) | 42 |
| Wafer (from Example 2) | 24 |
| Total | 100 |

In this embodiment, the chocolate coating included sugar, chocolate liquor (processed with alkali), cocoa butter, milk fat, soy lecithin and vanillin (i.e., artificial flavor).

In this embodiment, 13 grams of the chocolate coated peanut butter wafer had the following nutritional characteristics: about 70 calories; about 3.5 grams of total fat (about 27%); about 1.5 grams of saturated fat (about 11.5%); no trans fat; no cholesterol; about 20 milligrams of sodium; about 6 grams of total carbohydrates (about 46.2%); about 4 grams of sugar (about 30.8%); and about 3 grams of protein (about 23.1%).

It will be apparent by those of ordinary skill in the art that the amount of ingredients in the wafer, the filling composition, and the coating may vary and may include other ingredients or trace ingredients used to preserve freshness and/or texture of the product. These variations may also slightly affect the nutritional characteristics of the food composition.

### Example 10

In yet a further embodiment, the various components (i.e., the wafer, the crème, and the coating) of the cookie may be each manufactured at a first geographic location, and shipped or transported to a second geographic location. For instance, the wafers may be produced at a first location for shipment to a food manufacturer at a second location, such that the food manufacturer is enabled to combine the various components and create the cookie using pre-manufactured components of the cookie.

At least one of the food ingredients of a food product of the present invention may be admixed with another food ingredient or, optionally all of the food ingredients of the food products, to form a blend of food ingredients that partially or completely make up the food product (i.e., the wafer or the crème composition). This blend of food ingredients may be packaged and shipped or sent to a food manufacturer or other consumer, along with indicia associated with the blend of food ingredients directing the food manufacturer or consumer of how to prepare the food product.

This embodiment saves the food manufacturer or consumer time in that the blend of food ingredients comes pre-mixed and in a proper ratio such that the food manufacturer or consumer does not need to weight out and measure the individual ingredients. Further, the food manufacturer or consumer does not have to pay to ship a water component of the blend of final food product since the blend may be shipped dry. Thus, the food manufacturer or consumer may simply produce the food product in accordance with the indicia associated therewith.

This embodiment also enables the production of a more consistent food product in that a lot or shipment of one ingredient may have specifications that vary from time to time. Thus, the blend may be produced to accommodate for such variations that may exist with the specifications of different lots of the ingredient. For instance, various flours or protein isolates may have varying protein contents, wherein this variation may be accounted for by adding another protein concentrate or adjusting the amount of the ingredient added to the blend.

### Example 11

In yet an additional embodiment, a wafer was produced with the following ingredients:

| | Weight |
|---|---|
| Ingredient | percentage |
| Water | 59.8% |
| Flour (13% protein) | 18.8% |
| Kansas Diamond Brand whole wheat flour, available | 12.7% |
| from ADM Milling of Overland Park, Kansas | |
| PROFAM 825 brand soy protein isolate available from | 4.8% |
| Archer Daniels Midland Company, Decatur, IL | |
| Baking soda | 0.2% |
| Egg white powder | 1.9% |
| Novalipid brand 106-150 interesterified soybean available | 1.0% |
| from Archer Daniels Midland Company, Decatur, IL | |
| PROLITE 100 brand wheat protein isolate available | 1.0% |
| from Archer Daniels Midland Company, Decatur, IL | |
| Total | 100.00% |

The ingredients were mixed or blended to form a batter. The batter was subjected to a pressure molding system, heated, and cooked to form wafers.

The produced wafers have the following nutritional profile, per 100 grams of the wafers, there were: 380 calories, of which 50 calories are from fat; 6 grams of total fat; 1 gram of saturated fat; 0 grams of trans fat; 0 milligrams of cholesterol; 57 grams of total carbohydrate; 4 grams of dietary fiber; 1 gram of sugars; and 22 grams of protein.

### Example 12

In yet another embodiment, a filling composition was prepared with the following ingredients:

| Ingredients | % in formula |
|---|---|
| Peanut butter (roasted peanuts and | 32.96 |
| salt) | |
| PROFAM 825 brand soy protein | 23.12 |
| isolate available from Archer Daniels | |
| Midland Company, Decatur, IL | |
| Sugar | 11.13 |
| NovaLipid brand 106-150 shortening, | 11.35 |
| interesterified soybean oil, available | |
| from Archer Daniels Midland | |
| Company, Decatur, IL | |
| Canola oil | 7.68 |
| Lecithin | 1.27 |
| Peanut oil flavor | 0.49 |
| Total | 100 |

The ingredients were mixed together to form a crème type material or filling composition. The crème may be used as a filling composition for incorporation into a food stuff, placed between two wafers or used as a coating for a foodstuff. The crème may also contain a colorant to give the crème a desired color and optionally an added flavoring agent.

### Example 13

In yet a further embodiment, a coating was prepared with the following ingredients:

| Ingredients | % in formula |
|---|---|
| FIBERSOL-2 brand digestion resistant | 34.81 |
| maltodextrin available from Archer | |
| Daniels Midland Company, Decatur, IL | |
| Chocolate liquor | 43.34 |
| Cocoa butter | 13.07 |
| Natural cocoa powder | 7.16 |
| Sugar | 1.00 |
| Soy lecithin | 0.55 |
| Sucralose | 0.059 |
| Vanilla | 0.01 |
| Total | 100 |

The dry ingredients (i.e., the FIBERSOL-2 brand digestion resistant maltodextrin, cocoa powder, sugar and sucralose) were mixed together to form a dry mix. A portion of the cocoa butter was added to the dry mix and refined. The remaining ingredients were added and mixed well under heating to formed a liquid coating. In another embodiment, the sugar could be completely removed to form a sugar-free coating composition.

### Example 14

In yet another embodiment, wafers produced from Example 11, the filling composition of Example 12, and the coating composition of Example 13 were used to form a food stuff. The food stuff was made by placing the filling composition on a wafer and/or between two wafers, thus, forming a core comprising the wafer and the filling composition. The core was coated or enrobed with the coating composition. The food stuff included about 24.1% wafer, about 43.9% of the filling composition, and about 32% of the coating composition.

The food stuff was configured as a bar such that a serving size was two bars having a mass of about 26 grams. One serving size of the bar was calculated to have the following nutritional profile: about 130 calories, of which 70 calories were from fat; 8 grams of total fat; 2.5 grams of saturated fat; 0 grams of trans fat; 0 milligrams of cholesterol; 40 milligrams of sodium; 11 grams of total carbohydrate; 5 grams of dietary fiber; 2 grams of sugar; and 5 grams of protein.

### Example 15

In another embodiment, a coating was prepared with the following ingredients:

| Ingredients | % in formula |
|---|---|
| Maltitol | 40.00 |
| Chocolate liquor | 30.00 |
| Alkalized chocolate liquor | 10.00 |
| Cocoa butter | 15.00 |
| Natural cocoa powder | 2.44 |
| Sugar | 2.00 |
| Soy lecithin | 0.55 |
| Vanilla | 0.01 |
| Total | ˜100 |

The dry ingredients (i.e., the cocoa powder and sugar) were mixed together to form a dry mix. A portion of the cocoa butter was added to the dry mix and refined. The remaining ingredients were added and mixed well under heating to form a liquid coating. In this example, the sugar may be removed to make the coating “sugar-free.”

### Example 16

In a further embodiment, a coating was prepared with the following ingredients:

| Ingredients | % in formula |
|---|---|
| FIBERSOL-2 brand digestion resistant | 34.40 |
| maltodextrin available from Archer | |
| Daniels Midland Company, Decatur, IL | |
| Chocolate liquor | 41.28 |
| Cocoa butter | 14.70 |
| Natural cocoa powder | 6.85 |
| Sugar | 1.96 |
| Soy lecithin | 0.74 |
| Acesulfame-K | 0.068 |
| Vanilla | 0.01 |
| Total | ˜100 |

The dry ingredients (i.e., the FIBERSOL-2 brand digestion resistant maltodextrin, cocoa powder, sugar and acesulfame-K) were mixed together to form a dry mix. A portion of the cocoa butter was added to the dry mix and refined. The remaining ingredients were added and mixed well under heating to formed a liquid coating. In another embodiment, the sugar could be completely removed and the acesulfame-K percentage raised to about 0.177% to form a sugar-free coating composition.

### Example 17

In yet a further embodiment, a coating was prepared with the following ingredients:

| Ingredients | % in formula |
|---|---|
| FIBERSOL-2 brand digestion resistant | 35.17 |
| maltodextrin available from Archer | |
| Daniels Midland Company, Decatur, IL | |
| Chocolate liquor | 42.20 |
| Cocoa butter | 13.00 |
| Natural cocoa powder | 7.00 |
| Sugar | 2.00 |
| Soy lecithin | 0.55 |
| Acesulfame-K | 0.07 |
| Vanilla | 0.01 |
| Total | 100 |

The dry ingredients (i.e., the FIBERSOL-2 brand digestion resistant maltodextrin, cocoa powder, sugar and sucralose) were mixed together to form a dry mix. A portion of the cocoa butter was added to the dry mix and refined. The remaining ingredients were added and mixed well under heating to formed a liquid coating. In another embodiment, the sugar could be completely removed and the acesulfame-K percentage raised to about 0.177% to form a sugar-free coating composition.

### Example 18

In another embodiment, at least one of the food ingredients of a food product of the present invention may be admixed with another food ingredient or, optionally all of the food ingredients of the food products, to form a blend of food ingredients that partially or completely make up the food product (i.e., the wafer or the crème). This blend of food ingredients may be packaged and shipped or sent to a food manufacturer or other consumer, along with indicia associated with the blend of food ingredients directing the food manufacturer or consumer of how to prepare the food product.

This embodiment saves the food manufacturer or consumer time in that the blend of food ingredients comes pre-mixed and in a proper ratio such that the food manufacturer or consumer does not need to weight out and measure the individual ingredients. Further, the food manufacturer or consumer does not have to pay to ship a water component of the blend of final food product since the blend may be shipped dry. Thus, the food manufacturer or consumer may simply produce the food product in accordance with the indicia associated therewith.

This embodiment also enables the production of a more consistent food product in that a lot or shipment of one ingredient may have specifications that vary from time to time. Thus, the blend may be produced to accommodate for such variations that may exist with the specifications of different lots of the ingredient. For instance, various flours or protein isolates may have varying protein contents, wherein this variation may be accounted for by adding another protein concentrate or adjusting the amount of the ingredient added to the blend.

The present invention has been described with reference to certain exemplary embodiments, food ingredients, food compositions and uses thereof. However, it will be recognized by those of ordinary skill in the art that various substitutions, modifications or combinations of any of the exemplary embodiments may be made without departing from the spirit and scope of the invention. Thus, the invention is not limited by the description of the exemplary embodiment, but rather by the appended claims as originally filed.

1-56. (canceled)

57. A food compositing comprising:
a wafer comprising a whole wheat flour;
a filling contacting at least a portion of the wafer, the filling comprising:
a fat, an oil or a combination thereof; and
a coating covering at least a portion of the wafer.

58. The food composition of claim 57, wherein the fat, the oil or the combination thereof of the filling comprises an interesterified oil.

59. The food composition of claim 57, wherein the filling further comprises a protein isolate selected from the group consisting of soy protein isolate, wheat protein isolate, whey protein isolate, canola protein isolate, egg protein, and any combinations thereof.

60. The food composition of claim 57, wherein the coating comprises:
a sweetener; and
a soluble fiber selected from the group consisting of polydextrose, a digestion resistant maltodextrin, inulin, and any combinations thereof.

61. The food composition of claim 60, wherein the sweetener of the coating is selected from the group consisting of sucralose, acesulfame-K, maltitol, and any combination thereof.

62. The food composition of claim 57, wherein twenty six grams of the food composition comprises at least five grams of dietary fiber.

63. The food composition of claim 57, wherein twenty six grams of the food composition comprises at least five grams of protein.

64. The food composition of claim 57, the wafer further comprising a protein selected from the group consisting of wheat protein, soy protein, whey protein, egg protein and any combination thereof.

65. A food composition comprising:
a wafer comprising:
a flour; and
a protein selected from the group consisting of soy protein, wheat protein, whey protein, egg protein and any combination thereof; and
a filling contacting at least a portion of the wafer, the filling comprising:
a protein isolate; and
trans-fat free oil.

66. The food composition of claim 65, further comprising:
a coating covering at least a portion of the wafer, the coating comprising:
a sweetener; and
a soluble fiber.

67. The food composition of claim 65, wherein the trans-fat free oil comprises an interesterified oil.

68. The food composition of claim 65, wherein the protein isolate of the filling is selected from the group consisting of soy protein isolate, wheat protein isolate, whey protein isolate, canola protein isolate, egg protein, and any combinations thereof.

69. The food composition of claim 65, wherein the flour of the wafer comprises whole wheat flour.

70. A food compositing comprising:
a wafer;
a filling contacting at least a portion of the wafer; and
a coating covering at least a portion of the wafer;
wherein twenty six grams of the food composition comprises at least four grams of dietary fiber, at least four grams of protein or a combination thereof.

71. The food composition of claim 70, wherein the wafer comprises whole wheat flour.

72. The food composition of claim 70, wherein the filling comprises a peanut product.

73. The food composition of claim 70, wherein the coating comprises:
a sweetener;
a chocolate product; and
a soluble fiber.

74. The food composition of claim 73, wherein the soluble fiber of the coating is selected from the group consisting of polydextrose, a digestion resistant maltodextrin, inulin, and any combination thereof.

75. A food product configured as a molded wafer, comprising:
whole wheat flour; and
a protein selected from the group consisting of soy protein, wheat protein, whey protein, canola protein, egg protein, and any combinations thereof.

76. The food product of claim 75, wherein the food product comprises at least 3 percent dietary fiber on a dry weight basis.
